(19) United States
(12) Patent Application Publication
(10) Pub. No.: US 2020/0058223 A1
(43) Pub. Date: Feb. 20, 2020

(54) OBJECT FILTERING MOTION DETECTION SYSTEM

(71) Applicants: Nikos Perivolaris, Etobicoke (CA); Richard Zhivko, Hamilton (CA)

(72) Inventors: Nikos Perivolaris, Etobicoke (CA); Richard Zhivko, Hamilton (CA)

(21) Appl. No.: 16/524,770

(22) Filed: Jul. 29, 2019

Related U.S. Application Data
(60) Provisional application No. 62/712,344, filed on Jul. 31, 2018.

(51) Int. Cl. G08G 1/16; H04W 4/48; H04W 88/02; G08B 5/22; G08B 3/10

(52) U.S. Cl. CPC G08G 1/166; H04W 4/48; B60Q 9/00; G08B 5/228; G08B 3/1016; H04W 88/02

(57) ABSTRACT

The object-filtering motion detection system disclosed herein may comprise, at least, a plurality of motion sensors, an indicator display, and a means for attachment to a vehicle. The combination may be installed on or integrated into any type of vehicle, especially including service vehicles, busses, or commercial vehicles. The system is designed to comprise a limited detection range and alert only to human-sized objects, so as to reduce or eliminate false or excessive alerts that may cause a user to ignore the alerts. The system may implement wireless connectivity to enhance applicability and expandability of the system, and may further interface with a given vehicle to power on and off automatically with the vehicle itself. The system may also comprise an alerting means that a user may carry on their person, so that they are alerted to persons within the proximity of the vehicle when they are away from the vehicle.

### TECHNICAL FIELD OF THE INVENTION

The present invention relates in general to motion sensors, and, more specifically, to an object-filtering motion detection system.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A motion detector is a device that detects moving objects and people, and such a device is often integrated as a component of a system that automatically performs a task or alerts a user of motion in an area. Motion detectors typically comprise a sensor and some type of interface activated by a signal from the sensor, and the types of sensors used vary based on the particular application of a given system. Examples of such sensors include the use of passive infrared (PIR), microwave detection, ultrasonic frequency detection, tomographic motion detection, gesture detection, and video camera detection.

One subtype of motion detectors is known as occupancy sensors, which includes indoor motion detecting devices used to detect the presence of a person to automatically control, for example, lights or temperature and ventilation systems. Such systems, though, like all motion detectors, only detect for motion, and do not distinguish between sources of motion. As such, a system controlled by such a sensor may be inefficiently triggered by any motion, whether human or otherwise.

A second subtype of motion detectors is known as blind spot monitors, which includes vehicle-based sensor devices that detect other vehicles located to the driver's sides and rear. Some blind spot monitors may also detect objects forward of the driver, such as cross-traffic or pedestrians. Such systems, again, only detect for motion, though more accurately detect the presence of an object within the detection arc. These systems, as with all motion detection systems, cannot discriminate between various objects and, thus, may trigger an alert as a result of any infringement of the detection system. Such alerting is inefficient for the purposes of the present invention.

Thus, there is a need in the art for an object-filtering motion detection system that may trigger an alert when the presence of a person is detected, though which does not trigger an alert in response to infringement from other objects. It is to these ends that the present invention has been developed.

### BRIEF SUMMARY OF THE INVENTION

To minimize the limitations in the prior art, and to minimize other limitations that will be apparent upon reading and understanding the present specification, the present invention describes an object-filtering motion detection system.

It is an objective of the present invention to provide an object-filtering motion detection system that may alert to the presence of a person in the detection field.

It is another objective of the present invention to provide an object-filtering motion detection system that may filter out larger objects in the detection field.

It is another objective of the present invention to provide an object-filtering motion detection system that may comprise a plurality of motion sensors.

It is another objective of the present invention to provide an object-filtering motion detection system that may comprise an indicator display.

It is another objective of the present invention to provide an object-filtering motion detection system that may comprise a means for attachment to a vehicle.

It is another objective of the present invention to provide an object-filtering motion detection system that may comprise a means for attachment to a user.

It is another objective of the present invention to provide an object-filtering motion detection system that may comprise wireless connectivity.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an overall perspective view of an indicator display of an object-filtering motion detection system, as contemplated by the present invention;

FIG. 2 illustrates an overall perspective view of a motion sensor of an object-filtering motion detection system, as contemplated by the present invention;

FIG. 3 illustrates an overall perspective view of a means for attachment to a vehicle of an object-filtering motion detection system, as contemplated by the present invention; and

FIG. 4 illustrates an overall perspective view of an object-filtering motion detection system installed on an exemplary vehicle, as contemplated by the present invention.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The purpose of the system is to provide an alert mechanism to vehicle operators of any persons approaching the vehicle in which they may be sitting. The system provides the vehicle operator with an opportunity to appropriately react to approaching persons or threats by either engaging or disengaging from the situation. The system may be implemented as a vehicle operator safety device, but may also present as a safety mechanism for pedestrians or cargo contained within the vehicle.

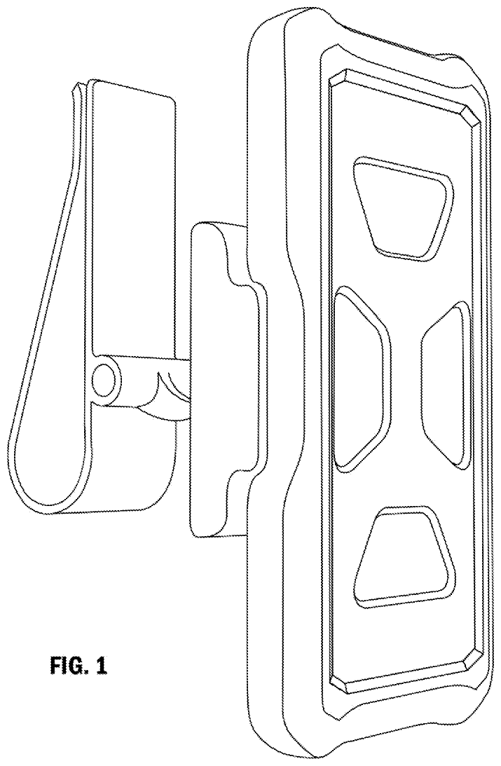

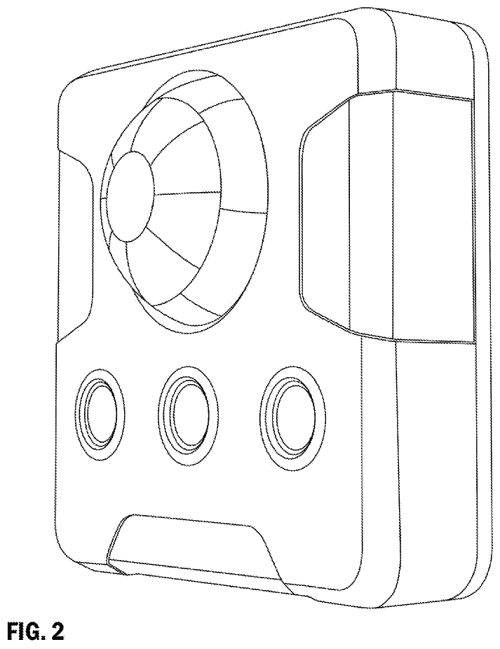

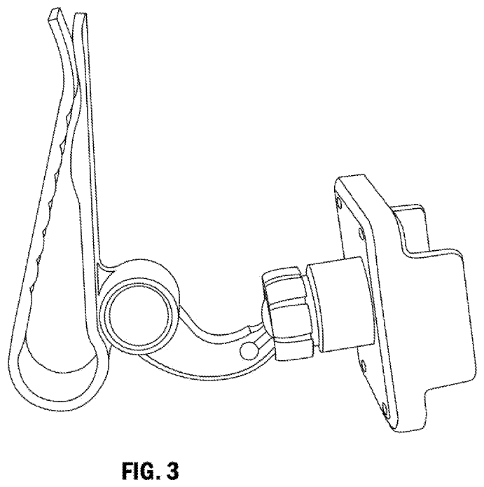

The illustrations of FIGS. 1-3 illustrate an object-filtering motion detection system as contemplated by the present invention. The combination may comprise, at least, a plurality of motion sensors and an indicator display. The system may further comprise a means for attachment to a vehicle and a means for attachment to a user. The plurality of motion sensors may comprise any sensor known in the art, and may project a limited-range arc or sphere of detection area. The range of the detection area may be limited so as to ensure accuracy and appropriate functionality of the system. In a preferred embodiment the range of the sensor detection area may be limited to approximately 30 feet, as motion detected beyond this range would not be useful to the purpose of the invention. The arc or sphere of detection may comprise any angle of coverage within the limitations of the sensor design, and may have an upper limit of 180 degrees or may be designed to provide an even larger coverage arc or sphere.

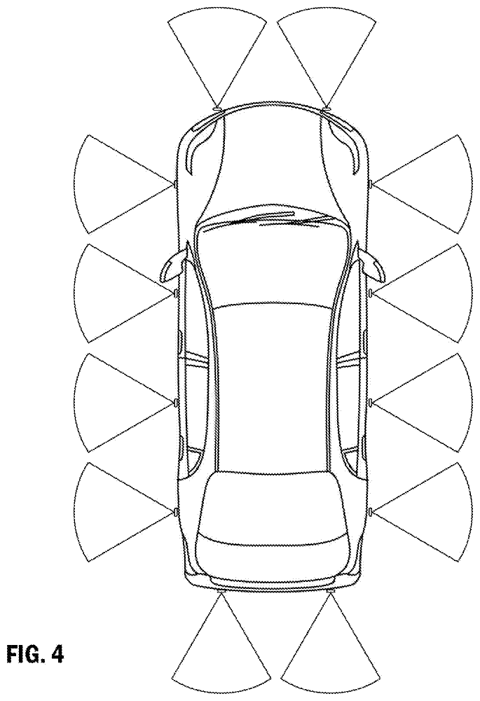

The illustration of FIG. 4 illustrates an overall perspective view of an object-filtering motion detection system installed on an exemplary vehicle. The plurality of motion sensors may be installed on a vehicle at various points to provide the required arc or sphere of detection coverage. By way of example, a smaller car may have one or more sensor installed on the front edge of the vehicle, one or more sensors installed on the rear edge of the vehicle, and one or more sensors installed on the sides of the vehicle. Such an arrangement may provide complete sensor detection area around the vehicle up to the desired range limitation. In an alternative embodiment a plurality of sensors may be installed on the roof of a vehicle if appropriate to the available space or design of the vehicle. On a larger vehicle, such as a bus or tractor-trailer combination, multiple sensors may be installed along the sides and rear of the trailer to provide adequate detection area.

The plurality of motion sensors may be designed to specifically identify persons within the detection arc or sphere by any appropriate means. By way of example, the motion sensors, which are set to a limited detection range, may only alert to movement of a particular size within the detection arc or sphere. Such a limitation to, for example, smaller objects may eliminate the false triggering of alerts by the presence of larger objects such as other vehicles. Through these methods the system may only alert a user to the presence of other persons within proximity of the vehicle. The method further eliminates the constant alerting present in alternative systems, which often result in a user ignoring alerts or disabling the notification system.

The plurality of motion sensors may interface wirelessly, preferably by radio or Bluetooth signal, to a central receiver and indicator display combination. The indicator display may display system detections by any appropriate means, though preferably displays detections by a plurality of visual indicators identifying the direction, relative to the vehicle, of the detection. The indicator display may further comprise an audible alarm, though this alarm may preferably be disabled or enabled by user preference. The indicator display may also further comprise a visual alarm that may be preferably disabled or enabled by user preference. The indicator display itself may attach to a visor clip and cradle combination or a suction-cup and cradle combination so that the indicator display may be quickly and easily viewed by a user sitting in the vehicle.

Considered advantageous to the present combination is the incorporation of object-filtering motion detection and notification only, and the specific removal of automated responses by the system itself. By way of example, alternative systems incorporate automatic window closing, door locking, or horn honking means to add an additional layer of provided features. The present system, by contrast, would be hindered by the addition of such additional features as they would interfere with the user's ability to determine an appropriate response to the detected motion.

The present combination may be designed to operate on 12 v power from a vehicle battery, and may be incorporated into the vehicle system such that the system may be turned on and off with other vehicle accessories. The system may, instead, be powered independently of the vehicle systems, if preferred. The advantage of having the system connected to vehicle power is to avoid the system being disabled due to user error while the vehicle is turned on. The accessing of such power may occur by any appropriate means, and may specifically including wiring the system directly to vehicle power or integrating a cigarette lighter or universal serial bus (USB) connector that may connect to the vehicle. For use in commercial or service vehicles with specialized connectors, the system may instead comprise connectors intended for such systems.

The system may further comprise a means for attachment to a user, which may manifest as a pager or a software application, which the user may carry on their person when stepping away from the vehicle. Such a means for attachment to a user may provide a secondary means for user notification to, for example, a police officer who has stepped away from his vehicle with the vehicle having been approached during the interim.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. An object-filtering motion detection system, comprising:
a plurality of motion sensors; and
an indicator display;
wherein each of said plurality of motion sensors have a detection area.

2. The invention of claim 1,
wherein said plurality of motion sensors are installed on a vehicle; and
wherein said plurality of motion sensors create a coverage area around said vehicle.

3. The invention of claim 2,
wherein each of said plurality of motion sensors distinguish between a human movement and a non-human movement.

4. The invention of claim 3,
wherein each of said plurality of motion sensors triggers an alert when said human movement is detected within said coverage area.

5. The invention of claim 4,
wherein each of said plurality of motion sensors does not trigger an alert when said non-human movement is detected within said coverage area.

6. The invention of claim 5, further comprising:
a means for wireless communication;
wherein said alert is transmitted wirelessly to said indicator display.

7. The invention of claim 6, further comprising:
a means for attachment to a vehicle;
wherein said indicator display is attached to said vehicle via said means for attachment to a vehicle.

8. The invention of claim 7, further comprising:
a means for remote notification;
wherein said alert is transmitted wirelessly to said means for remote notification.

9. The invention of claim 8,
wherein said means for attachment to a vehicle is a visor clip and cradle combination.

10. The invention of claim 8,
wherein said means for attachment to a vehicle is a suction cup and cradle combination.

11. The invention of claim 8,
wherein said indicator display further comprises a visual display; and
wherein said visual display presents said alert to a user.

12. The invention of claim 8,
wherein said indicator display further comprises an audible alarm; and
wherein said audible alarm presents said alert to a user.

13. The invention of claim 8,
wherein said detection area comprises a limited arc.

14. The invention of claim 8,
wherein said limited arc detects motion up to 30 feet away.

15. The invention of claim 8,
wherein said detection area comprises a limited sphere.

16. The invention of claim 8,
wherein said limited sphere detects motion up to 30 feet away.

17. The invention of claim 8,
wherein said means for remote notification comprises a proprietary hardware.

18. The invention of claim 8,
wherein said means for remote notification comprises a software application installed on a user's smartphone.

19. The invention of claim 8,
wherein the object-filtering motion detection system is powered by a power source connected to said vehicle.
